(19) United States
(12) Patent Application Publication
(10) Pub. No.: US 2001/0045430 A1
(43) Pub. Date: Nov. 29, 2001

(54) Portable cooking apparatus

(76) Inventor: Heshmat Bashra Mawoud, Staten Island, NY (US)

Correspondence Address: Matthew J. Peirce, Esq., 1550 Starlight Canyon Avenue, Las Vegas, NV, 89123, US

(21) Appl. No.: 09/863,243

(22) Filed: May 22, 2001

Related U.S. Application Data
(60) Provisional application No. 60/206,696, filed on May 24, 2000.

(51) Int. Cl. H05B 6/80

(52) U.S. Cl. 219/756; 219/715

(57) ABSTRACT

A new and improved microwave oven is disclosed which would be transportable and possess alternate power means other than a standard household alternating current connection. The present invention would be analogous to a standard microwave oven but would be approximately the size of a small to medium-sized toaster oven. In addition, the present invention could use one of several possible power sources, including a cigarette lighter adapter, a 12 volt battery, or a rechargeable battery. The present invention would be very convenient for a driver or passengers of a vehicle, and would also be convenient for outdoor use in a wide variety of situations.

### I. BACKGROUND OF THE INVENTION

The present invention concerns that of a new and improved microwave oven which would be transportable and possess alternate power means other than a standard household alternating current connection.

### II. DESCRIPTION OF THE PRIOR ART

U.S. Pat. No. 5,369,255, issued to Sherer et al., discloses a unit which is suitable for storing and carrying food and includes a microwave therein.

U.S. Pat. No. 4,904,837, issued to Low et al., discloses a microwave oven which is suitable for use on transports where DC power is available.

U.S. Pat. No. 4,667,075, issued to Sakurai, discloses a microwave oven for a camping or other vehicle which includes a heating room in which an object is heating by applying microwaves thereto, a microwave guide to propagate the microwaves into the heating room, a magnetron to produce the microwave for the microwave guide, and a voltage supply device to supply the magnetron with an appropriate voltage.

### III. SUMMARY OF THE INVENTION

The present invention concerns that of a new and improved microwave oven which would be transportable and possess alternate power means other than a standard household alternating current connection. The present invention would be analogous to a standard microwave oven but would be approximately the size of a small to medium-sized toaster oven. In addition, the present invention could use one of several possible power sources, including a cigarette lighter adapter, a 12 volt battery, or a rechargeable battery. The present invention would be very convenient for a driver or passengers of a vehicle, and would also be convenient for outdoor use in a wide variety of situations.

There has thus been outlined, rather broadly, the more important features of a portable microwave oven in order that the detailed description thereof that follows may be better understood and in order that the present contribution to the art may be better appreciated. There are, of course, additional features of the portable microwave oven that will be described hereinafter and which will form the subject matter of the claims appended hereto.

In this respect, before explaining at least one embodiment of the portable microwave oven in detail, it is to be understood that the portable microwave oven is not limited in its application to the details of construction and to the arrangements of the components set forth in the following description or illustrated in the drawings. The portable microwave oven is capable of other embodiments and being practiced and carried out in various ways. Also, it is to be understood that the phraseology and terminology employed herein are for the purpose of descriptions and should not be regarded as limiting.

As such, those skilled in the art will appreciate that the conception, upon which this disclosure is based, may readily be utilized as a basis for the designing of other structures, methods and systems for carrying out the several purposes of the present portable microwave oven. It is important, therefore, that the claims be regarded as including such equivalent constructions insofar as they do not depart from the spirit and scope of the present invention.

It is therefore an object of the present invention to provide a portable microwave oven, which has all of the advantages of the prior art and none of the disadvantages.

It is another object of the present invention to provide a portable microwave oven which may be easily and efficiently manufactured and marketed.

It is another object of the present invention to provide a portable microwave oven which is of durable and reliable construction.

It is yet another object of the present invention to provide a portable microwave oven which is economically affordable and available for relevant purchasing government entities.

Other objects, features and advantages of the present invention will become more readily apparent from the following detailed description of the preferred embodiment when considered with the attached drawings and appended claims.

### IV. BRIEF DESCRIPTION OF THE DRAWINGS

FIG. 1 shows a perspective view of the present invention.

FIG. 2 shows a rear view of the present invention.

### V. DESCRIPTION OF THE PREFERRED EMBODIMENT

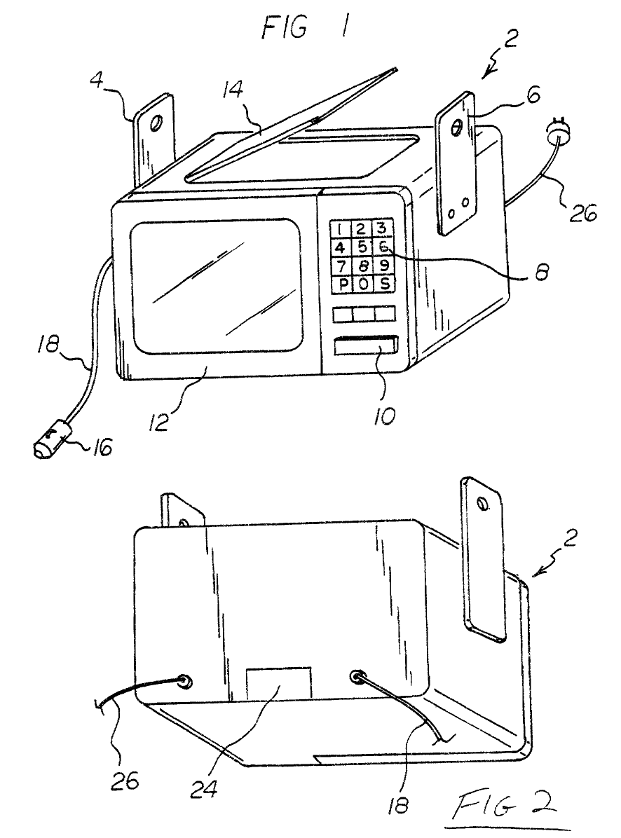

FIG. 1 shows a perspective view of the present invention. The present invention includes microwave unit 2, mounting brackets 4 and 6, numerical keypad 8, door button 10, front door 12, top door 14, cigarette lighter adapter 16, and cord 18. Mounting brackets 4 and 6 would be removable and would be used by a user if the user would want to attach the present invention to some type of ceiling within a vehicle.

Numerical keypad 8 would be used to properly program the time, timer, and cooking times for food in microwave unit 2. Door button 10 would be designed to pop open both front door 12 and top door 14. The present invention, unlike most conventional microwaves, would include top door 14. Top door 14 might be the preferred door to use when a user might be travelling at high rates of speed, whereby the easiest method of getting into the microwave would be through the top.

As shown in FIG. 1, the present invention includes cigarette lighter adapter 16, which is attached to microwave unit 2 by cord 18. The present invention, in the configuration seen, would be powered by plugging cigarette lighter adapter 16 into a cigarette lighter socket on a vehicle. Cord 18 would connect cigarette lighter adapter 16 to microwave unit 2 of the present invention.

In various alternative embodiments not shown, the present invention, in lieu of cigarette lighter adapter 16, could include a battery 20 or rechargeable battery 22. Either battery 20 or rechargeable battery 22 would be housed within battery compartment 24, which would be located near the rear of microwave unit 2.

FIG. 2 shows a rear view of the present invention. Battery compartment 24 can be seen, along with the connection point of cord 18 to microwave unit 2. Any particular unit of the present invention could possess all three alternative methods of powering the present invention, so as to not limit a user's options as to how to power the present invention.

In addition, the present invention could be designed to have electrical cord 26, which would allow the present invention to use standard household current. Of course, a user would only use standard household current if the present invention was located in a person's house. However, this may be the preferred method of providing power to the present invention at certain times.

What I claim as my invention is:

1. A portable cooking apparatus comprising:
(a) a microwave oven having a front face, a rear face, a left face, and a right face, the microwave oven further including two surfaces, a top surface and a bottom surface,
(b) a front door pivotally mounted to the microwave oven,
(c) a door button located on the front face of the microwave oven, the door button designed to open the front door when the front door would be flush with the microwave oven,
(d) a numerical keypad located on the front face of the microwave oven, the numerical keypad allowing a user to input cooking time for the microwave oven, among other functions,
(e) mounting means for mounting the microwave oven within a vehicle,
(f) a cigarette lighter adapater,
(g) an electrical cord to connect the cigarette lighter adapter to the microwave oven,
(h) a power source for providing power to the microwave oven, and
(i) a battery compartment accessible through the rear face of the microwave oven.

2. A portable cooking apparatus according to claim 1 wherein the length of the microwave oven would be approximately ten to twelve inches, and further wherein the depth of the microwave oven would be approximately nine to ten inches.

3. A portable cooking apparatus according to claim 1 wherein the mounting means for mounting the microwave oven within a vehicle would further comprise a pair of mounting brackets, a first bracket and a second bracket, the first bracket being fixedly attached to the left face of the microwave oven, the second bracket being fixedly attached to the right face of the microwave oven.

4. A portable cooking apparatus according to claim 1 wherein the microwave oven would further comprise a top door, the top door being pivotally attached to the top surface of the present invention, the top door being openable with the door button.

5. A portable cooking apparatus according to claim 1 wherein the power source would comprise direct current from a vehicle, the direct current being accessible by plugging the cigarette lighter adapter into the cigarette lighter holder within the vehicle.

6. A portable cooking apparatus according to claim 1 wherein the power source would be at least one battery.

7. A portable cooking apparatus according to claim 6 wherein the battery used as the power source would be a 12-volt battery.

8. A portable cooking apparatus according to claim 6 wherein the battery used as the power source would be a rechargeable battery.
